(19) United States
(12) Patent Application Publication
(10) Pub. No.: US 2024/0336815 A1
(43) Pub. Date: Oct. 10, 2024

(54) FOAMED ACRYLIC POLYMER PRIMERLESS ADHESIVE

(71) Applicant: Illinois Tool Works Inc., Glenview, IL (US)

(72) Inventors: Peter A. Carbutt, Glenview, IL (US); Masaki Minato, Glenview, IL (US)

(73) Assignee: Illinois Tool Works Inc., Glenview, IL (US)

(21) Appl. No.: 18/626,385

(22) Filed: Apr. 4, 2024

Related U.S. Application Data
(60) Provisional application No. 63/458,209, filed on Apr. 10, 2023.

(51) Int. Cl. C09J 9/00; B32B 5/18; B32B 7/12; B32B 15/04; C08J 9/04; C09J 11/08; C09J 133/02; C09J 133/12

(52) U.S. Cl. CPC C09J 9/00; B32B 5/18; B32B 7/12; B32B 15/046; C08J 9/04; C09J 11/08; C09J 133/02; C09J 133/12; B32B 2250/02; B32B 2255/06; B32B 2255/20; B32B 2266/0221; B32B 2266/08; C08J 2203/18; C08J 2205/052; C08J 2333/02; C08J 2333/12

(57) ABSTRACT

A composition of matter is provided for preparing a foamed polymer adhesive includes a reactive mixture, a free radical-producing catalyst, and a foaming agent. The reactive mixture includes methacrylate ester monomer and a thermoplastic polymer soluble therein. The polymerization reaction causing shrinkage of the reactive mixture. The foaming agent causes expansion of the reactive mixture to form a closed celled foam that offsets at least in part the shrinkage of the reactive mixture caused by the polymerization reaction. The foaming agent includes an acid-neutralizing base and a second part being an acid that is ethylenically saturated or aromatic. A substrate is bonded by the adhesive independent of an intervening primer. The adhesive can be formed at a variety of densities and prevents print through on opposing sides of the substrate. A substrate with an oxide or oil coating can be bonded without removal of the coating.

### RELATED APPLICATIONS

This application claims priority benefit of U.S. Provisional Application Ser. No. 63/458,209, filed Apr. 10, 2023; the contents of which are hereby incorporated by reference.

### FIELD OF THE INVENTION

The present invention relates to a polymer curative adhesive, and more particularly to a foaming acrylic curative adhesive for bonding plastics and metals without the use of a primer pretreatment and without heating.

### BACKGROUND OF THE INVENTION

Foamed or cellular polymers have been commercially accepted in a wide variety of applications for a number of years. A foamed or cellular polymer or plastic is defined as a plastic the apparent density of which is decreased substantially by the presence of numerous cells disposed throughout its mass. The terms cellular plastic or polymer, foamed plastic or polymer, expanded plastic or polymer, and plastic or polymer foam have been used interchangeably to denote two-phase gas-solid systems in which the solid is continuous and composed of a synthetic polymer or rubber.

Polymers used in a large number of industrial foamed compositions are cellulose acetate, epoxy resins, styrene/polyester resins, phenolic resins, polyethylene, polystyrene, silicones, urea-formaldehyde resins, polyurethanes, latex foam rubbers, natural rubber, synthetic-elastomers, poly (vinyl chloride), ebonite, and polytetrafluoroethylene. Foamed polymers have been used for, structural support, insulation, both sound and temperature, in furniture padding and in mattresses, as sponges, in packing materials, in plastic articles, as adhesives and the like.

Curing adhesives, including foamed adhesive compositions, have been in use for many years to bond a wide variety of like materials, including thermoset plastics, thermoplastics, metals, wood, ceramics and other materials in the manufacture of transportation vehicles such as cars, trucks, and boats. However, certain characteristics make these curing adhesives less desirable to use as widely as they might otherwise be used.

As an initial matter, such adhesives are typically only able to bond substrates of like materials, for example, metal to metal, plastic to plastic, and/or wood to wood. Furthermore, such adhesives typically require extensive surface preparation of the substrate, such as sanding, cleaning, and/or priming prior to application of the adhesive in order to achieve a strong bond between the substrates. Furthermore, many of these adhesives require the application of heat in order to cure the adhesive, which increases manufacturing times, reduces throughput, and subjects the bonded part to temperatures it may not otherwise be suitable for. An additional drawback of existing adhesives is the problem of dimpling or rippling at the site of adhesive application, known in the automobile industry as “bond line read through” or “print through” due to the bonded materials having different coefficients of linear thermal expansion and due to volumetric shrink in the adhesives. Such unintended texturization at the site of adhesive application is particularly undesirable in the transportation manufacturing industries given that automobiles, boats, and planes are expected to have sleek smooth exterior surfaces, known in the industry as a “Class A” surface finish.

In order to overcome some of these issues, namely the requirement of heat application in order to cure the adhesive, room temperature curing adhesives have been made. There are three common classes of two-part room temperature curing reactive adhesives. These are epoxies, polyurethanes, and acrylics.

Epoxy adhesives, which are the earliest, best known and among the most common structural adhesives in general use, consist of an epoxy resin adhesive component and an amine, polyamide, or combined amine and polyamide hardener components. Faster curing epoxies can be formulated with polymercaptan hardeners that are generally used in combination with polyamide and amine hardeners. Epoxy-resin foams are characterized by good adhesive strength, which is important when foamed-in-place formulations are used, low water absorption, good dimensional stability, good heat resistance and, generally, good chemical resistance. The properties of rigid and semi-rigid epoxy foams are comparable to polyurethane formulations. However, because of the availability of lower cost foams with properties adequate for most commercial applications and because of the difficulties in achieving elastomeric epoxy systems, epoxy-resin foams are employed in somewhat specialized applications.

Polyurethane adhesives generally consist of an isocyanate-terminated polyol and a hardener or curative component that consists of a polyol or amine or a combination of polyols and amines. Polyurethanes are used widely in foamed plastic applications even though isocyanates used in making polyurethanes present environmental problems. Polyurethanes find limited use in foamed adhesive compositions due to the fact that bonding of the polyurethane to a substrate requires, in most cases, a primer to enhance or maintain adhesion.

The epoxy and polyurethane adhesives cure upon mixing when the hardener component reacts with the epoxy or polyurethane resin component in an addition polymerization process.

Methacrylate or acrylic adhesives that are used in the same applications as epoxies and polyurethanes generally consist of a polymer-in-monomer solution of an elastomer or thermoplastic resin or a combination thereof in a monomer such as methyl methacrylate. Hardening is achieved when a combination of a peroxide and an amine is introduced into the polymer-in-monomer mixture to initiate a free-radical curing reaction. Generally, the adhesive component contains either the amine or peroxide component and the co-reactive peroxide or amine component is mixed with the adhesive just prior to bonding. Acrylic systems using methyl methacrylate as the primary monomer are very prone to volumetric shrink, which leads to print through, as described above. The use of fillers in such adhesives helps to significantly reduce such print by disrupting the polymer chains from aligning and compacting as they cure. However, the addition of such fillers typically come with a loss of physical properties such as shear strength or temperature resistance.

Each of the three common reactive adhesive classes has characteristic advantages and disadvantages. For example, epoxies tend to be characterized as safe and relatively easy to mix and apply but tend to be somewhat rigid and sensitive to cleanliness of the surface to be bonded. Polyurethanes are generally considered to be much more flexible and elastic, but also suffer from sensitivity to surface contamination, moisture and humidity. Both of these adhesive types have the limitation that fast-curing products tend to have very short open working time after mixing, and products with more acceptable open time have very long cure times. This limitation is imposed by the linear reaction mechanism that is characteristic of the addition polymerization reaction by which they cure. As described above, acrylic systems using methyl methacrylate as the primary monomer are very prone to volumetric shrink, which leads to print through.

In terms of the characteristics of the cured adhesive and resulting bond, epoxies are considered to be very strong because of their high modulus or rigidity and resulting high lap shear strength. They are generally recommended for bonding metals because of their affinity for metal surfaces and high shear strengths. However, their rigid nature limits their usefulness in applications that require flexibility in the adhesive bond. Epoxies also have limited ability to bond thermoplastic materials.

Polyurethanes are generally much more elastic, tough and flexible than epoxies. Elasticity, toughness and flexibility are beneficial when adhesive bonds are subjected to peeling or impact forces, and when bonds and bonded assemblies are subjected to dynamic fatigue stresses. However, polyurethanes are not as useful as epoxies for bonding metals, and are generally more suitable for bonding plastic materials in applications that are subjected to bending and impact stresses.

Two-part acrylic or methacrylate adhesives overcome two of the major drawbacks of the epoxies and polyurethanes. They are much more tolerant of unclean or unprepared surfaces, and they have a much more favorable cure profile in terms of open working time and cure rate. In addition, they exhibit equal or better affinity for metal and plastic surfaces than either epoxies or polyurethanes. However, some materials, in particular certain composite materials, are difficult to bond in the “as received” condition. Specific examples include certain gel coats, which are highly crosslinked and inert polyester compounds that form the outer or “show” surface of fiberglass reinforced polyester (FRP) composite materials, sheet molding compounds (SMC), resin transfer molded (RTM) composites and pultruded composites used to fabricate vehicle components, boats, and other structures exposed to outdoor weathering. Additionally, as described above, acrylic systems using methyl methacrylate as the primary monomer are very prone to volumetric shrink, which leads to print or read through, unless filler is included. However such fillers tend to reduce the strength of such adhesives. Commonly owned U.S. Pat. No. 5,945,461 is exemplary of these formulations that met with limited acceptance owing the need for priming all but plastics substrates and the volume shrinkages that were routinely about 12 percent resulting in bond line read through.

Thus, there is a need for an adhesive that will reliably and predictably bond a wide variety of material surfaces in the as received condition, rapidly and without the application of heat to complete the cure or develop full adhesive bond strength. There is a further need for an adhesive to bond a variety of structural materials such as metal, thermoplastics, wood, without resort to the need for priming prior to applying the adhesive composition to the substrates. There is a still further need to control volume changes upon cure so the result cure adhesive prevents bond line read out even when bonding materials having different coefficients of linear expansion and without the degradation of its physical properties.

### SUMMARY OF THE INVENTION

A composition of matter is provided for preparing a foamed polymer adhesive includes a reactive mixture, a free radical-producing catalyst, and a foaming agent. The reactive mixture includes 30 to 95 percent by weight of a methacrylate ester monomer, including an ester group selected from the group consisting of allyl, cycloalkyl, and alkoxy groups, having 1 to about 12 carbon atoms; and 5 to 70 percent by weight of a thermoplastic polymer soluble in the monomer. The polymerization reaction causing shrinkage of the reactive mixture. The free radical-producing catalyst is present in an amount sufficient to polymerize the reactive mixture. The foaming agent causes expansion of the reactive mixture to form a closed celled foam that at the correct loading offsets at least in part the shrinkage of the reactive mixture caused by the polymerization reaction. The foaming agent includes a first part being an acid-neutralizing base and a second part being an acid that is ethylenically saturated or aromatic.

A structure is provided with a first substrate having a first contacting surface and a first opposing surface and an adhesive formed by the cure of the composition of matter in contact with the first contacting surface of the first substrate and independent of a primer between the adhesive and the first contacting surface.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a plot of displacement as a function of force for a T peel test of an inventive cured adhesive in which the force of peel propagation does not significantly drop after the initiation; and

FIG. 2 is a plot of extension as a function of load for a conventional adhesive per U.S. Pat. No. 5,945,461 without and with prior substrate prime in comparison to an inventive cured adhesive that shows superior performance relative to the conventional adhesives.

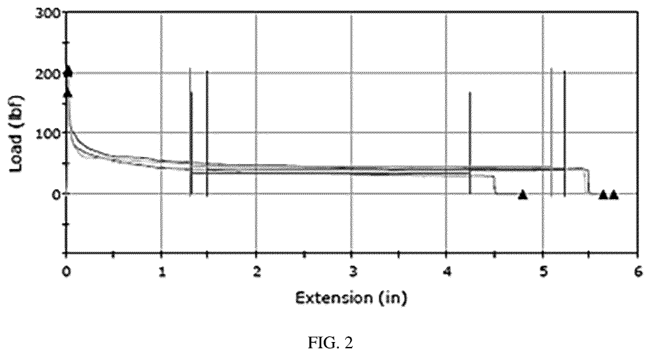

### DETAILED DESCRIPTION OF THE INVENTION

The present invention has utility as foaming acrylic curative adhesive for bonding a wide variety of material surfaces, such as plastics and metals, in the as received condition. The present invention also provides the desired properties without the prior application of primer to a substrate. The present invention also provides adhesive cure at ambient temperature and thus without the application of heat to complete the cure or develop full adhesive bond strength. Cure times are adjustable within a range of times suitable for desired working times and then cure. According to embodiments, foaming action in a liquid adhesive is controlled to produce various levels of closed cell bubbles within the foam to counteract the shrinkage that occurs as a function of reactive mixture polymerization cure and is not dependent on a heat of reaction or external heat to create the foaming reaction as seen with other materials such as expand cells, which do require such heat.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, a composition of matter for preparing a foamed polymer adhesive at ambient temperature includes a reactive mixture which undergoes a polymerization reaction at ambient temperature, a free radical-producing catalyst, and a foaming agent which causes expansion of the composition of matter at ambient temperature.

As used herein, ambient temperature is defined as a temperature of between-40 and 40 degrees Celsius with an appreciation that in most manufacturing environments, ambient temperature is between 10 and 30 degrees Celsius.

According to embodiments, the reactive mixture includes 30 to 95 percent by weight of a methacrylate ester monomer, including an ester group selected from the group consisting of allyl, cycloalkyl, and alkoxy groups, having 1 to about 12 carbon atoms and 5 to 70 percent by weight of a thermoplastic polymer soluble in the monomer. The polymerization reaction has a tendency to cause shrinkage of the reactive mixture, which as described above, tends to cause unintended texturizing on the bonded substrates, known as print through. According to embodiments, the free radical-producing catalyst is in an amount sufficient to polymerize the reactive mixture. According to embodiments, the foaming agent is present in an amount sufficient that the expansion caused by the foaming agent at least offsets the shrinkage of the reactive mixture caused by the polymerization reaction, which is typically 12 to 14%. According to embodiments, the foaming agent includes a first part being a weak base and a second part being a weak acid.

Print through is synonymously referred to herein as bondline read through and is readily quantified by the techniques detailed in Deslauriers, Paul, and Hannes Fuchs. “Finite Element Modeling of Bond-Line Read-Through in Composite Automotive Body Panels Subject to Elevated Temperature Cure.” SPE ACCE Conference (2010).

According to embodiments, the monomers useful in this invention are alkyl methacrylate ester monomers wherein the ester group is an alkyl, cycloalkyl or alkoxy group which contains one to about 12 carbon atoms. Examples of such monomers are methyl methacrylate, ethyl methacrylate, iso-butyl methacrylate, t-butyl methacrylate, n-butyl methacrylate, 2-ethylhexyl methacrylate, cyclohexyl methacrylate, lauryl methacrylate and the like. The preferred monomer is methyl methacrylate.

Additional monomers which can be used in combination with the methacrylate monomers are alkyl acrylates wherein the alkyl group contains two to about 12 carbon atoms, examples of which are ethyl acrylate, n-butyl acrylate, isobutyl acrylate, t-butyl acrylate, 2-ethylhexyl acrylate, lauryl acrylate and the like. Other useful monomers are acrylonitrile, methacrylonitrile, styrene, vinyl toluene, and the like.

According to embodiments, preferred monomer compositions contain at least about 50 weight percent alkyl methacrylate, and most preferably, at least about 50 weight percent methyl methacrylate wherein said weight percents are based on the total monomer weight.

Di- or poly functional vinyl, allyl, acrylate or methacrylate monomers or oligomers, can be added to crosslink the polymer if desired. In the absence of such additives, the acrylate or methacrylate polymer is largely thermoplastic in nature. The addition of crosslinking monomers confers a degree of thermoset character in proportion to the amount added. Such characteristics as heat and solvent resistance, as well as certain physical or mechanical properties, are enhanced or modified by such additions, according to the principles well known to those skilled in the art. The polyfunctional monomers are those which contain 2 or more polymerizable ethylenically unsaturated groups and, preferably, two to six ethylenic groups. Examples of such compounds are the diacrylic or methacrylic acid esters of ethylene glycol, propylene glycol, butanediol, hexandediol, and polyoxyalkylene glycols, di and tri acrylic or methacrylic esters of hexanetriol, trimethylol ethane, and trimethylol propane, di, tri and tetra acrylic or methacrylic esters of pentaerythritol, diallyl maleate, diallylfumarate, divinyl benzene, diacrylic or methacrylic esters of hydroxy terminated urethane prepolymers and the like. If used, the polyfunctional monomers will comprise up to about 10 weight percent based on the total weight of monomers.

Ethylenically unsaturated free radical polymerizable carboxylic acids can also be used in combination with the alkyl methacrylate monomers. Such acids, generally, contain one or two carboxylic acid groups and three to about 10 carbon atoms. Examples of such acids are acrylic acid, methacrylic acid, crotonic acid, maleic acid, fumaric acid, itaconic acid, and alkyl half-esters of maleic or fumaric acids wherein the alkyl group contains one to six carbon atoms. The preferred acid for use in this invention is methacrylic acid. Such acids are utilized in the amount of zero up to about 10 weight percent based on the total weight of monomers.

Polymers useful in this invention are those polymers which are soluble in the monomers described hereinabove. Such polymers which form “polymer-in-monomer” solutions should have molecular weights of at least about five thousand up to about one million or more. The molecular weight should not be greater than a value compatible with the solubility in the chosen monomer. As used herein, molecular weights of polymers are number-average molecular weight values, unless noted otherwise.

Polymers operative in the present invention are elastomeric polymers although other polymers, such as homo and copolymers of styrene, acrylonitrile, vinyl acetate, alkyl acrylates, e.g., ethyl acrylate, alkyl methacrylates, e.g., methyl methacrylate, vinyl chloride, vinylidene chloride and vinyl butyral, can be used. Elastomeric polymers, which are defined by ASTM as materials that can be stretched at room temperature to twice their length, held for 5 minutes, and upon release will return to within 10 percent of their original length over a similar period of time, include such polymers as natural rubber, isoprene rubber, butadiene rubber, chloroprene rubber, isobutylene-isoprene rubber, nitrile-butadiene rubber, styrene butadiene rubber, ethylene-propylene copolymers ethylene-propylene-diene terpolymers, silicones, fluoroelastomers, polyacrylates, polyethers, e.g., polyepichlorohydrin, chlorosulfonated polyethylene, chlorinated polyethylene, ethylene-acrylic copolymers, polypropylene oxide, thermoplastic elastomers, and thermoplastic resins.

The above-described elastomeric polymers are thermoplastic in nature as used in this invention, since they, generally, are used in the “soluble” or non-crosslinked state. True thermoplastic elastomers, those which are designed to be processed and used in substantially non-vulcanized form, are also useful in the present invention, provided they can be dissolved or dispersed in the monomers.

Thermoplastic elastomers, often referred to as elastoplastics, combine many of the good properties of vulcanized elastomers with the processing characteristics of thermoplastics.

Thermoplastic elastomers are described in detail in Kirk-Othmer “Encyclopedia of Chemical Technology”, 3rd Ed., Vol 8, pages 626-638, which is hereby incorporated by reference. The preferred thermoplastic elastomers for use as the polymer-in-monomer are the styrene-diene block copolymers, e.g., block copolymers of styrene and butadiene or isoprene, as described in detail in U.S. Pat. Nos. 4,041,103 and 4,242,470 which are hereby incorporated by reference.

Mixtures of polymers can be used as the “polymer-in-monomer”. The polymers are soluble in the monomers so as to form polymer-in-monomer solutions of from about 10 to about 60 weight percent polymer based on the weight of the solution. As used herein, the term “solution” is intended to cover not only true solutions but colloidal dispersions which exhibit normal or substantially newtonian rheology characteristics. According to embodiments, the amount of polymer used in this invention is about 10 to about 60 weight percent based on the total composition weight, and, preferably, about 20 to about 50 weight percent.

Additional polymers which can be used in combination with the polymer of the “polymer-in-monomer” are core-shell graft polymers which swell in the monomers but do not dissolve in them. The “core” or backbone polymer of the graft copolymer has a glass transition temperature substantially below ambient temperatures. The “shell” polymer which is grafted onto the backbone polymer has a glass transition temperature substantially above ambient temperatures. Ambient temperature is defined as the temperature range in which the composition is used.

Examples of useful core-shell graft copolymers are those where “hard” monomers, such as styrene, acrylonitrile or methyl methacrylate, are grafted on to a rubbery core made from polymers of “soft” or “elastomeric” monomers, such as butadiene or ethyl acrylate.

U.S. Pat. No. 3,985,703, which is hereby incorporated by reference, describes useful core-shell polymers, the cores of which are made preferably from butyl acrylate but can be based on ethyl, isobutyl, 2-ethylhexyl, or other alkyl acrylates or mixtures thereof. The core polymer, optionally, can contain up to 20 percent of other copolymerizable monomers, such as styrene, vinyl acetate, methyl methacrylate, butadiene, isoprene and the like. The core polymer can also contain up to 5 percent of a crosslinking monomer having two or more nonconjugated double bonds of approximately equal reactivity, such as ethylene glycol diacrylate, butylene glycol dimethacrylate and the like. It also optionally can contain up to 5 percent of a graft-linking monomer having two or more nonconjugated double bonds of unequal reactivity, such as diallyl maleate and allyl methacrylate.

The shell stage is preferably polymerized from methyl methacrylate and optionally other lower alkyl methacrylates, such as ethyl, butyl, or mixtures thereof. Up to about 40 percent by weight of the shell monomers can be styrene, vinyl acetate, vinyl chloride, and the like.

Additional useful core-shell graft copolymers are described in U.S. Pat. Nos. 3,948,497, 4,096,202, and 4,034,013, which are hereby incorporated by reference.

Still other useful core-shell polymers are the “MBS” polymers such as those described in U.S. Pat. No. 4,304,709 which is hereby incorporated by reference. The MBS polymers are made by polymerizing methyl methacrylate in the presence of polybutadiene or polybutadiene copolymer rubber.

Other patents which describe various useful core-shell graft copolymers are U.S. Pat. Nos. 3,944,631, 4,306,040 and 4,495,324, each of which is hereby incorporated by reference.

The core-shell graft copolymers are used in this invention in the amount of about 0 to about 25 weight percent, preferably, about 10 to about 20 weight percent, wherein said weight percents are based on the total weight of the composition.

Additional components of the composition of this invention are polymerization catalysts with or without other components which enhance the reactivity of the catalysts. The catalysts are free radical generators which trigger the polymerization of acrylate and methacrylate compounds. Such catalysts are peroxides, hydroperoxides, peresters, peracids, radiant energy, e.g., ultraviolet light, and heat. Examples of these catalysts are benzoyl peroxide, cumene hydroperoxide, tertiary butyl hydroperoxide, dicumyl peroxide, tertiary butyl peroxide acetate, tertiary butyl perbenzoate, ditertiary butyl azodiisobutyronitrile and the like. These free radical producing catalysts are used in amounts of about 0.01 to about 10 weight percent based on the weight of the composition. Preferably, the catalysts will be used in the amount of about 0.05 to about 3 weight percent. Some catalysts, such as benzoyl peroxide, are supplied as diluted or extended pastes for safety and handling reasons. The amount used in such cases refers to the active ingredient content.

Other components which enhance the reactivity of the catalysts are initiators or activators and promoters. Initiators and activators, which terms are used inchangeably, include tertiary amines and aldehyde-amine reaction products. Useful tertiary amines include N,N-dimethylaniline, N,N-dimethyltoluidine, N,N-diethylaniline, N,N-diethyltoluidine, N,N-bis (2-hydroxyethyl-p-toluidine, N,N-diisopropanol-p-toluidine, and the like. Aldehyde-amine reaction products include such compositions as the reaction products of butyaldehyde-aniline and butyraldehyde-butylamine.

The promoter is an organic salt of a transition metal, such as cobalt, nickel, manganese or iron naphthenate, copper octoate, copper acetylacetonate, iron hexoate, or iron propionate.

The initiators or activators, if used, are added in the amount of up to about 15 weight percent based on the weight of the compositions. Preferred amounts are 0.01 to about 5 weight percent. Promoters are used in amounts up to about 0.5 weight percent, preferably about 1 part per million to about 0.5 weight percent.

Foaming agents used in this invention are any of the foaming agents commonly used in the foamed polymer art. Examples of such foaming agents include gas and low boiling liquids as well as chemical foaming agents which are by a chemical reaction when two or more components are mixed together. Notably, the present invention does not require the application of heat to activate the foaming agent.

Examples of gaseous and low boiling liquid foaming agents include air, nitrogen, carbon dioxide, the various halocarbons, including fluorocarbons, chlorofluorocarbons, and chlorocarbons, the pentanes, hexanes, acetone, methyl ethyl ketone and the like.

According to embodiments, the foaming agent is a multipart foaming agent that includes a first part being an acid-neutralizing base and a second part being an acid.

An acid-neutralizing base operative herein is limited only by compatibility with the reactive mixture and the ability to evolve gas through the neutralization process. A gas-evolving neutralizing base according to the present invention generates a gas such as carbon dioxide, dinitrogen or dioxygen upon reaction with the acid. A carbonate, peroxide, borohydride, or azide operative in the present invention as a neutralizing agent is one capable of neutralizing the acid. Carbonates operative herein include carbonates where the cation is an alkali metal, alkali earth, hydrogen, ammonium, tetraorganal ammonium, transition metals, alone, or in combination with hydrogen. Peroxides operative herein illustratively include sodium perborate and sodium percarbonate. Sodium azide is an exemplary azide operative herein. Specific examples of carbonates operative herein illustratively include sodium carbonate, sodium bicarbonate, magnesium carbonate, calcium carbonate, aluminum carbonate, and ammonium carbonate. It is appreciated that inventive carbonate is typically in the form of a solid particulate dispersed in a storage stable portion of the reactive mixture. Additionally, it is appreciated that the ability of a carbonate to neutralize acid, and in the process deliver a carbon dioxide, is largely independent of the nature of the cation. The gas-evolving neutralizing base is present from 0.1 to total weight percent and in some inventive embodiments, the gas-evolving neutralizing agent is present in a stoichiometric amount or excess of about 10 equivalent percent relative to the acid equivalents of the acid.

The only requirements as to the identity of an acid operative in the present invention are that the acid have a pKa value sufficient to generate a high enough proton ion concentration to induce active carbon dioxide generation and that the acid salt be compatible with substrate contact. U.S. Pat. No. 5,945,461 teaches the use of acids that contain unsaturated carbon-carbon double bonds and include acrylic acid, methacrylic acid, crotonic acid, maleic acid, fumaric acid, itaconic acid, and alkyl half-esters of maleic or fumaric acids. In contrast to U.S. Pat. No. 5,945,461; the acids of the present invention are either aliphatically saturated, or are aromatic. Without intending to be bound to a particular theory, the acids of the present invention are unreactive in the course of adhesive cure and as a result retain function as an interfacial primer with the surface and/or function in foaming; and critically are not reactive during acrylic cure. In some inventive embodiments, the acid is in a solid and dry form. An acid operative herein includes C₂-C₂₀ organic mono- and poly-carboxylic acids devoid of ethylenic unsaturations, and especially alpha- and beta-hydroxycarboxylic acids; C₂-C₂₀ organophosphorus acids such as phytic acid; and C₂-C₂₀ organosulfur acids such as toluene sulfonic acid. Typical hydroxycarboxylic acids include gluconic, glucoheptonic, 2-hydroxyisovaleric, tartaric, lactic, salicylic and citric acids as well as acid-forming lactones such as gluconolactone and glucarolactone. Still other specific acids operative herein illustratively include formic, acetic, propionic, butyric, valeric, hexanoic, caproic, caprylic, capric, lauric, myristic, palmitic, stearic, propionic, benzoic, toluic, and anthranilic, as well as dicarboxylic acids such as oxalic, adipic, glutaric, succinic, malonic, succinic, glutaric, adipic, malic, and phthalic acids. Lastly, in the case of sodium borohydride as the acid neutralizing base, water functions as the acid. It is appreciated that the polymerizable acid referred to hereinbefore is not counted toward that of the acid portion of the two-part foaming agent used herein.

The foaming agents are mixed with the monomer-polymer solutions of this invention and are activated upon creation of a reaction mixture from storage stable parts to bring the acid-neutralizing base into reactive contact with the saturated or aromatic acid. A surprising aspect of the inventive foaming agent system is that it also functions as a self-primer for metal and plastic substrates even if the substrate has an oil or oxide coating thereon.

The amount of foaming agent used in this invention will vary widely depending on a variety of factors including neutralization kinetics, pKa values, and the nature of the evolved gas. The amount of foaming agent to be used is based on the desired density of the foamed composition. The amount will vary from an amount which is sufficient to overcome the shrinkage that occurs during the polymerization reaction, i.e., wherein the density after polymerization is about the same as the density before polymerization, to an amount which produces a low density foam, i.e., a foam having a density as low as 0.25 g/cc or less. The exact amount of foaming agent to be used can be readily determined by those skilled in the art.

Other useful additives that are well-known in the foamed polymer art and which can optionally be used to advantage in foamed acrylic compositions, are nucleating agents and surface active agents or surfactants. These additives provide sites for initiation of bubble formation and stabilize the bubbles as they grow and form cell walls and membranes. Effective use of such additives enhances cell formation and can improve the ultimate size, shape, and uniformity of the final cell structures.

The compositions of the present invention can be formulated for use in many existing applications of cellular or expanded plastics and elastomers. However, specific application, performance, physical aging, personal safety, environmental and economic benefits influence the applications for which they can provide the greatest practical or commercial advantage. In many cases, they will find utility in applications in which no currently acceptable product is totally acceptable. In general, the instant compositions provide the greatest advantage in applications that currently use semi-rigid or flexible, two-part polyurethane, epoxy, or polyester resins.

Polyurethane foams are very well established and economical materials for general-purpose structural applications, such as furniture padding, cushioning, and insulation. While there is no intention to exclude those applications, the benefits offered by foamed acrylic compositions, are of most immediate advantage:
1) In applications requiring durable adhesive bonds to such materials as metals, plastics and composites, painted surfaces, wood and other structural or decorative materials, alone or in combinations. Acrylic based compositions are well known for their outstanding bonding capabilities, and usually require very little or no cleaning or other surface treatments. According to embodiments of the present invention, the foamed polymer adhesive is self-priming, meaning that the substrates to be bonded are able to be bonded using the inventive adhesive when the substrate are in an as received condition, without the use of a primer such that there is no intermediate layer that is applied before the adhesive is applied to the substrate surface. Very clean and often primed surfaces are needed for durable, long-lasting bonds with polyurethanes, while in the present invention oil-based or oxide coatings need not be removed prior to application of a reactive mixture of an inventive composition thereto;
2) In applications involving extended exposure to heat, ultraviolet rays, moisture, thermal cycling, and additional forms of outdoor or other in-service environments to which acrylic compositions are known to have superior resistance;
3) In applications incorporating both (1) and (2), such as lightweight structural adhesives and sealants; insulating tank coatings; void and seam fillers; gaskets; sound, vibration, and heat insulating coatings and the like. In many cases, polyurethane compositions require both a primer for adhesion and a protective coating after application. Such additional steps add cost, are time consuming, and provide opportunity for error;
4) In applications that require reduced emissions of toxic gases during overheating or combustion. Polyurethanes contain nitrogen which generates oxides and other toxic nitrogen compounds; preferred acrylic compositions for such applications can be formulated to contain, at most, traces of nitrogen or additional elements other than carbon, hydrogen, and oxygen. According to embodiments, the present invention is free of solvents in the foam cells, thus reducing rate of reaction issues and not contributing to flammability of the final cured adhesive;
5) In eliminating isocyanates in the work area; and
6) In eliminating the release of chlorofluorocarbons to the atmosphere.

Epoxide resin and catalyzed polyester/styrene foams address some of these issues, but because of their relatively poor cell structures and physical properties, the foams have limited usage relative to polyurethanes. In fact, aside from the compositions of the present invention, no class of thermoplastic or thermoset resins has provided the range of hardness, elasticity, and overall excellent foam properties of the polyurethanes.

When combined with the advantages noted above, the uniqueness and usefulness of these compositions are even more apparent, particularly for foamed-in-place applications.

Another benefit of the acrylate and methacrylate resins, especially for foamed-in-place uses, is their ease of handling, mixing, and application. In this respect, the foamed compositions provide the same well-known advantages of non-foamed acrylic materials over other materials, especially polyurethanes.

The most convenient method of applying foamed-in-place urethane is by dispensing a moisture-curable polyurethane foam precursor from a pressurized container such as an aerosol can, which has been charged with a propellant gas mixture that usually includes a chlorofluorocarbon foaming (or blowing) agent. Reaction of atmospheric moisture with active isocyanate groups in the dispensed foamed resin promotes crosslinking and cure of the foam. However, this method is limited in its number of useful applications, releases environmentally undesirable gases to the atmosphere, and requires formulas that contain relatively large amounts of free isocyanate monomers.

Two-component mixing of polyurethane foam precursors, one of which contains water to produce “water blown” foam, often produces foams with reduced physical structure and properties. Most often three components, one of which is a physical foaming agent, such as a halocarbons must be mixed simultaneously, in order to provide sufficient cell gas pressure for good foam formation as the polyurethane resin increases in viscosity through chemical reaction. The equipment for such three-component mixing is relatively complex and expensive.

Moreover, a high degree of component metering accuracy is necessary because polyurethane resins require precisely balanced mix ratios and thorough mixing for good results. In addition, the polyurethanes often require a long time to cure completely or must be heated in ovens to complete or speed up their curing.

The ease of handling, mixing, and application of the acrylic compositions is due to their free-radical cure mechanism. By contrast with the requirements of the addition-polymerized polyurethanes, complete curing and full physical properties can be obtained with much less rigorous mixing accuracy and intensity. As a result, simple metering systems and simple static mixers can be used to mix and dispense the foamed acrylic compositions. The multi-component polyurethanes generally require complex dynamic or mechanical mixers that are costly and require frequent cleaning and maintenance.

The acrylic curing mechanism is also responsible for the ability of the compositions to polymerize or cure rapidly and completely at ambient temperatures.

With respect to the handling and foaming process itself, another unique feature of the acrylic compositions of some inventive embodiments is their ability to dissolve and be storage-compatible with small amounts of water. Water is especially useful in the generation of foam from acid-neutralizing bases such as alkali earth and alkali metal carbonates, bicarbonates, and sodium borohydride. In the case of the aforementioned (bi) carbonates, water is believed to aid in the acid decomposition of the (bi) carbonate, to form carbon dioxide gas by aiding in the dissolution and/or disassociation of the gas generating components. The action of water on sodium borohydride causes decomposition and form hydrogen gas as the foaming substance.

In addition to promoting the evolution of the foaming gas, the solution compatibility of water is believed to further contribute to the foaming process. It is well-known in the art that some degree of compatibility between the polymer and the foaming agents is advantageous in the development of cell and foam structures and can reduce or eliminate the development of undesirably large bubbles that afford less structural strength to the cured adhesives and even more deleterious voids.

Moreover, the polymerization reaction in this invention occurs separately from the gas generation, that is, none of the polymer reactants are consumed by the foaming process itself. By contrast, water-blown polyurethane foams generate gas through reaction of isocyanate with water to form carbon dioxide. This consumes relatively expensive isocyanate monomer and can influence the properties of the urethane foam.

The complexity resulting from the simultaneously occurring processes of polymerization and foaming requires judicial and skillful manipulation of the compositional and process variables outlined above. As is well known in the vast art of polyurethane foam composition and processing, there is an extremely wide latitude in compositional and process variables available to those skilled in the art. The same holds true for the foamed compositions of this invention, and neither the preceding nor the following discussion is intended to be limiting in this respect, within the broad scope of the invention.

The effect of selected formulating variables on foamed polymer characteristics is illustrated by the discussion below and the examples that follow.

### Foam Density

The density of the polymeric foams described in this invention, as well as those known in the prior art, is a direct function of the amount and type of foaming agents used, alone or in combination. A more specifically useful feature of this invention is that a relatively low level of gas generation can help overcome shrinkage, a characteristic that is common to most acrylate or methacrylate polymers, and many other vinyl compositions. According to embodiments of the present invention, the foam density is further tunable for a desired application based on the type and amount of weak acid and weak based that are used in the foaming agent.

For example, methyl methacrylate, shrinks approximately 14 percent upon polymerization. This shrinkage can be partially offset by adding soluble polymers, fillers, etc, the reduction in shrinkage being roughly proportional to the amount of polymer or filler added. Even when so modified, these compositions undergo more shrinkage than typical epoxy or polyurethane formulations. This problem often results in such physical phenomena as: bondline “read through” when thin plastic panels are joined with acrylic adhesives; surface depressions when acrylic compositions are used in auto body repair or other filling applications; and surface depressions, imperfections and poor part size tolerances in casting applications.

By carefully adjusting the amount of gas generating components in the composition, it is possible to compensate for such shrinkage to eliminate the problems noted above even without resort to adding fillers, which tend to reduce the strength characteristics of the bond. Minimizing the amount of gaseous expansion products will minimize their effect on the physical properties of the cured compositions. Accordingly, the foamed polymer adhesive of the present invention is configured to form structural binds with the substrate to which the adhesive is applied without print through, described above, which is also known as bondline read through.

### Polymer Composition and Properties

A unique feature of the acrylic compositions of this invention is their wide range of formulating components and resulting range of physical properties. By varying the amount and type of elastomeric polymer or thermoplastic resin and core-shell graft polymers in the compositions, the properties of the cured polymer, and hence the resulting expanded or foamed polymer, can vary from a very low modulus rubber-like product to a rigid or semi-rigid product with high load bearing capability. Likewise, more subtle variation in the chemical make-up of the additive polymers can further influence properties such as resilience, or lack thereof, in the cured expanded polymer. The ability to adjust these physical properties is important in applications involving dynamic mechanical loads such as adhesive bonding, cushioning or shock absorption, mechanical and acoustic damping, and the like. Additional formulating additives such as fillers, plasticizers, crosslinking agents, and other materials well known to those skilled in the art, can be used to further influence these and other properties.

The addition of flame retarding fillers and additives can be used to advantage to produce expanded polymer products with varying degrees of resistance to ignition, combustion, flame spread, smoke evolution, and other important parameters relating to fire hazards. Specific polymer compositions can be selected so that toxic by-product emissions can be greatly reduced, especially compared with polyurethane foams which contain significant amounts of nitrogen and which are known to produce highly toxic combustion products.

### Regrind Compatibility and Reprocessability

An environmental and economic benefit of the expanded acrylic polymer products of the present invention is the compatibility with reprocessing or recycling operations. To illustrate by example, when two piece injection molded thermoplastic assemblies that have been adhesively bonded with an expanded methacrylate product are ground and added to virgin plastic pellets according to normal “regrind” processing procedures, the resulting parts and test specimens exhibit properties that are essentially identical to controls containing no methacrylate polymer.

Another form of recycling or reprocessing involves redissolving or redispensing cured methacrylate polymer in fresh monomer or fresh polymer-in-monomer solution. The resulting mixture can be catalyzed and polymerized to regenerate test specimens or articles that are very similar in appearance and performance to those made from fresh materials.

The reason for this ease of reprocessability is believed to derive at least in part from the fact that the cured compositions are largely thermoplastic in nature, especially in the absence of added crosslinking monomers.

By contrast, most expanded polyurethane compositions are thermosetting in nature, as are epoxy resin based materials. Often, recycling of such material, if feasible, involves grinding the products and using them as secondary fillers or extenders rather than regenerating like articles.

The compositions of this invention are usually prepared in two parts wherein one part contains the free radical catalyst and the other part contains the initiator or activator and the promoter if it is used. The foaming agent can be added to either or both parts. When a two part foaming agent is used, each component is added separately in the same manner as the free radical catalyst and activator are added. Just prior to use, the two parts are mixed together, and polymerization and foaming takes place.

The following examples describe the invention in more detail. Parts and percentages are by weight unless otherwise designated.

The components used in the examples are identified as follows:
MMA—Methyl methacrylate monomer containing 22-28 ppm of hydroquinone inhibitor.
MAA—Methacrylic acid containing 250 ppm of hydroquinone inhibitor
Styrene-butadiene branched copolymer
Styrene-isoprene-styrene block copolymer
Core-shell polymer of methyl methacrylate-butadiene styrene with high butadiene content
All acrylic core-shell polymer
Chlorosulfonated polyethylene containing 43 percent chlorine and 1.1 percent sulfur
Core-shell polymer of acrylate rubber core and styrene acrylonitrile shell
Hydrin 10×1—Liquid epichlorohydrin homopolymer with Brookfield viscosity (27° C.) of 2.5×105 cps, a Tg of −25° C., and a number average molecular weight of 4,000
Butyraldehyde—aniline condensation product
HET—N,N-bis (hydroxyethyl)-p-toluidine
NQ—1,4-napththoquinone
CHP—Cumene hydroperoxide, 80 weight percent in cumene
BHT—2,6-Di-tert-butyl p-cresol
BPO Paste Paste of 55 weight percent benzoyl peroxide in benzyl butyl phthalate plasticizer
Fumed silica
Polycarbonate/polyester thermoplastic resin
DDA Diisodecyl adipate

### EXAMPLES

The formulations of a Comparative Example devoid of lactic acid and bicarbonate and an inventive formulation otherwise the same except for stoichiometric inclusion thereof at 1 total weight percent with commensurate reduction in fumed silica filler, Example 1. These are applied to AL 6061 [The results are summarized in Table 1 in which the following abbreviations are used: RT denote 20 degrees Celsius, AF denotes adhesive failure, and CF denotes cohesive failure. Values are expressed in pounds per square inch (psi).

TABLE 1
Summary of Lap Shear Results on AL 6061 substrates.
Lap Shear - AL 6061

| | Comp. Ex. | Comp. Ex. | Ex. 1 |
|---|---|---|---|
| | without | With | (self- |
| | Primer | Primer | priming) |
| RT Shear | 300 | 930 | 1300 |
| Failure Mode | AF | CF | CF |
| −40 C. Shear | AF | 1911 | 2450 |
| Failure Mode | AF | CF | CF |

### Example 3—T Peel Testing

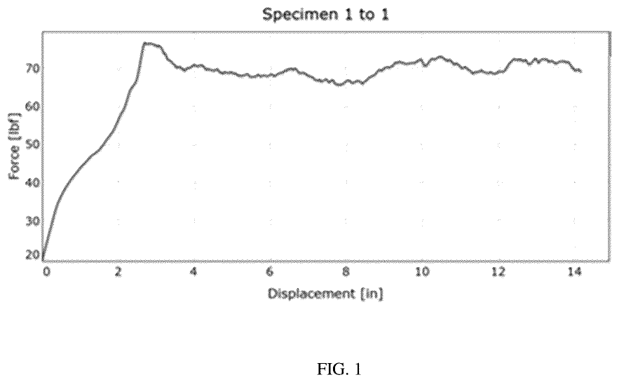

The composition of Example 1 is allowed to cure on unprimed, and as received, AL 6061 substrates to form T peel test units with like adhesive thickness to the Comparative Example. The unit is tested at 20 degrees Celsius according to ASTM D1876. The results are shown in FIG. 1 in which the propagation does not significantly drop after the initiation.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A composition of matter for preparing a foamed polymer adhesive comprising:
a reactive mixture having an uncured density, the reactive mixture undergoing a polymerization reaction comprising:
30 to 95 percent by weight of a methacrylate ester monomer, including an ester group selected from the group consisting of allyl, cycloalkyl, and alkoxy groups, having 1 to about 12 carbon atoms; and
5 to 70 percent by weight of a thermoplastic polymer soluble in the monomer;
the polymerization reaction causing shrinkage of the reactive mixture;
a free radical-producing catalyst, in an amount sufficient to polymerize the reactive mixture; and
a foaming agent that causes expansion of the reactive mixture, said foaming agent present in an amount sufficient to form a closed celled foam that offsets at least in part the shrinkage of said reactive mixture caused by the polymerization reaction, said foaming agent comprising a first part being an acid-neutralizing base and a second part being an acid that is ethylenically saturated an aromatic acid.

2. The composition of claim 1, wherein the monomer comprises at least about 50% by weight methyl methacrylate.

3. The composition of claim 2, wherein the monomer further comprises an ethylenically unsaturated polymerizable acid, present at up to about 10% by weight by the monomer.

4. The composition of claim 3, wherein the polymerizable acid comprises methacrylic acid.

5. The composition of claim 2, wherein the monomer further comprises a polyfunctional monomer which includes at least two polymerizable ethylenically unsaturated groups per molecule, the polyfunctional monomer being present at up to about 10% by weight of the monomer.

6. The composition of claim 5, wherein the polyfunctional monomer comprises 2 to 6 ethylenically unsaturated groups per molecule.

7. The composition of claim 1, wherein the thermoplastic polymer comprises an elastomer.

8. The composition of claim 1, wherein the polymerization reaction occurs at an ambient temperature of between-40 and 40 degrees Celsius.

9. The composition of claim 1, wherein the polymer is sufficiently soluble in the monomer to form a polymer-in-monomer solution including 5 to 70 percent of the polymer based on the weight of the solution.

10. The composition of claim 1, wherein the thermoplastic polymer further comprises a core-shell graft copolymer which swells in the monomer but does not dissolve therein, in an amount up to about 25% by weight of the polymer.

11. The composition of claim 10, wherein the core-shell polymer is present at about 10-20% by weight of the thermoplastic polymer.

12. The composition of claim 1, comprising sufficient foaming agent to obtain a polymerized foamed composition having a density of 0.25 g/cc to the uncured density.

13. The composition of claim 1, wherein the acid-neutralizing base and the acid are both present as solid particulates.

14. The composition of claim 1, wherein the acid is one or more of: C₂-C₂₀ organic mono- and poly-carboxylic acids devoid of ethylenic unsaturations, C₂-C₂₀ organophosphorus acids, or C₂-C₂₀ organosulfur acids.

15. A structure comprising:
a first substrate having a first contacting surface and a first opposing surface; and
an adhesive formed by the cure of the formulation of claim 1 in contact with the first contacting surface of said first substrate and independent of a primer between said adhesive and the first contacting surface.

16. The structure of claim 15, further comprising a second substrate having a second contacting surface and a second opposing surface, said adhesive being a foam in simultaneous contact between the first contacting surface and the second contacting surface.

17. The structure of claim 15, wherein said first substrate is a metal that has an oxide or oil coated on the first contacting surface.

18. The structure of claim 15, wherein upon modifying the temperature more than 10 degrees Celsius from the temperature of the cure no print through is observed on the opposing surface of said first substrate.

19. The structure of claim 18, wherein no print through is observed on the second opposing surface of said second substrate.

20. The structure of claim 15, wherein said adhesive is a closed celled foam that is independent of a solvent.
